(19) United States
(12) Patent Application Publication
(10) Pub. No.: US 2025/0115486 A1
(43) Pub. Date: Apr. 10, 2025

(54) METHOD OF MAKING CRYSTALLINE MATERIALS OF *BEA FRAMEWORK TYPE, CRYSTALLINE MATERIALS OBTAINABLE THEREFROM AND USES THEREOF

(71) Applicant: EXXONMOBIL TECHNOLOGY AND ENGINEERING COMPANY, Spring, TX (US)

(72) Inventors: Marc H. ANTHONIS, Hofstade (BE); Sina SARTIPI, Willebroek (BE); Scott J. WEIGEL, Allentown, PA (US)

(21) Appl. No.: 18/906,675

(22) Filed: Oct. 4, 2024

Related U.S. Application Data
(60) Provisional application No. 63/588,461, filed on Oct. 6, 2023.

(51) Int. Cl. C01B 39/48

(52) U.S. Cl. CPC C01B 39/48; C01P 2002/72; C01P 2004/03; C01P 2006/12; C01P 2006/80

(57) ABSTRACT

The present disclosure relates to a method of making crystalline materials of *BEA framework type. The present disclosure also relates to crystalline materials of *BEA framework type obtainable by said method and uses thereof. The method of making includes using 1,1-(pentane-1,5-diyl)bis(1-propylpyrrolidinium) dication as a structure directing agent for forming the crystalline materials of *BEA framework type.

### CROSS REFERENCE TO RELATED APPLICATIONS

The present application claims priority to and the benefit of U.S. Provisional Application No. 63/588,461 filed on Oct. 6, 2023 which is hereby incorporated by reference in its entirety.

### TECHNICAL FIELD

The present disclosure relates to a new method of making crystalline materials of *BEA framework type as well as to crystalline materials of *BEA framework type obtainable by said method and uses thereof.

### BACKGROUND OF THE INVENTION

Molecular sieve materials, both natural and synthetic, may be used as adsorbents and have catalytic properties for hydrocarbon conversion reactions. Certain molecular sieves, such as zeolites, AlPOs, and mesoporous materials, are ordered, porous crystalline materials having a definite crystalline structure as determined by X-ray diffraction (XRD). Certain molecular sieves are ordered and produce specific identifiable XRD patterns. Within certain molecular sieve materials there may be a large number of cavities, which may be interconnected by a number of channels or pores. These cavities and pores are uniform in size within a specific molecular sieve material. Because the dimensions of these pores are such as to accept for adsorption molecules of certain dimensions while rejecting those of larger dimensions, these materials have come to be known as “molecular sieves” and are utilized in a variety of industrial processes, e.g., cracking, hydrocracking, disproportionation, alkylation, oligomerization, and isomerization.

Molecular sieves that find application in catalysis and adsorption include any of the naturally occurring or synthetic crystalline molecular sieves. These zeolites and their isotypes are classified by the Structure Commission of the International Zeolite Association according to the rules of the IUPAC Commission on Zeolite Nomenclature. According to this classification, framework type zeolites and other crystalline microporous molecular sieves, for which a structure has been established, are assigned a three letter code and are described in the “Atlas of Zeolite Framework Types”, eds. Ch. Baerlocher, L. B. McCusker, and D. H. Olson, Elsevier, Sixth Edition, 2007, which is hereby incorporated by reference. These zeolites and their isotypes are also described in http://America.iza-structure.org/IZA-SC/ftc_table.php.

The idealized inorganic framework structure of zeolites is a framework of silicate in which all tetrahedral atoms are connected by oxygen atoms with the four next-nearest tetrahedral atoms. The term “silicate”, as used herein, refers to a substance containing at least silicon and oxygen atoms that are alternately bonded to each other (i.e., —O—Si—O—Si—), and optionally including other atoms within the inorganic framework structure, including atoms such as boron, aluminum, or other metals (e.g., transition metals, such as titanium, vanadium, or zinc). Atoms other than silicon and oxygen in the framework silicate occupy a portion of the lattice sites otherwise occupied by silicon atoms in an ‘all-silica’ framework silicate. Thus, the term “framework silicate” as used herein refers to an atomic lattice comprising any of a silicate, borosilicate, gallosilicate, ferrisilicate, aluminosilicate, titanosilicate, zincosilicate, vanadosilicate, or the like.

The structure of the framework silicate within a given zeolite determines the size of the pores or channels that are present therein. The pore or channel size may determine the types of processes for which a given zeolite is applicable. Currently, greater than 200 unique zeolite framework silicate structures are known and recognized by the Structure Commission of the International Zeolite Association, thereby defining a range of pore geometries and orientations.

The framework silicates of zeolites or molecular sieves are commonly characterized in terms of their ring size, wherein the ring size refers to the number of silicon atoms (or alternative atoms, such as those listed above) that are tetrahedrally coordinated with oxygen atoms in a loop to define a pore or channel within the interior of the zeolite. For example, an “8-ring” zeolite refers to a zeolite having pores or channels defined by 8 alternating tetrahedral atoms and 8 oxygen atoms in a loop. The pores or channels defined within a given zeolite may be symmetrical or asymmetrical depending upon various structural constrains that are present in the particular framework silicate.

Zeolites can be classified as having small, medium, large, and extra-large pore structures for pore windows delimited by 8, 10, 12, and more than 12 T-atoms, respectively. Extra-large pore zeolites (>12R) include, for example, AET (14R, e.g., ALPO-8), SFN (14R, e.g., SSZ-59), VFI (18R, e.g., VPI-5), CLO (20R, e.g., cloverite), and ITV (30R, e.g., ITQ-37) framework type zeolites. Extra-large pore zeolites generally have a free pore diameter of larger than about 0.8 nm. Large pore zeolites (12R) include, for example, LTL, MAZ, FAU, EMT, OFF, MTW, *BEA, MOR, and SFS framework type zeolites, e.g., mazzite, offretite, zeolite L, zeolite Y, zeolite X, omega, ZSM-2, ZSM-12, zeolite T, Beta, and SSZ-56. Large pore zeolites generally have a free pore diameter of 0.6 to 0.8 nm. Medium (or intermediate) pore size zeolites (10R) include, for example, MFJ, MEL, *MRE, EUO, MTT, MFS, AEL, AFO, HEU, FER, MWW, and TON framework type zeolites, e.g., ZSM-5, ZSM-11, ZSM-48, ZSM-22, ZSM-23, ZSM-35, MCM-22, silicalite-1, and silicalite-2. Medium pore size zeolites generally have a free pore diameter of 0.45 to 0.6 nm. Small pore size zeolites (8R) include, for example, CHA, RTH, ERI, KFI, LEV, and LTA framework type zeolites, e.g., ZK-4, SAPO-34, SAPO-35, ZK-14, SAPO-42, ZK-21, ZK-22, ZK-5, ZK-20, zeolite A, chabazite, and ALPO-17. Small pore size zeolites generally have a free pore diameter of 0.3 to 0.45 nm.

Synthesis of molecular sieve materials typically involves hydrothermal crystallization from a synthesis mixture comprising sources of all the elements present in the molecular sieve (or zeolite) such as sources of silica but also of alumina etc. In many cases a structure directing agent (SDA) is also present. Structure directing agents are compounds which are believed to promote the formation of molecular sieves and which are thought to act as templates around which certain molecular sieve structures can form and which thereby promote the formation of the desired molecular sieve. Various compounds have been used as structure directing agents including various types of quaternary ammonium cations. Typically, molecular sieve (or zeolite) crystals form around structure directing agents with the structure directing agent occupying pores in the molecular sieve once crystallization is complete. The “as-synthesized” (or “as-made”) molecular sieve will therefore contain the structure directing agent in its pores so that, following crystallization, the “as-synthesized” molecular sieve is usually subjected to a treatment step such as a calcination step to remove the structure directing agent.

For instance, U.S. Pat. No. 3,308,069 and J. B. Higgins et al., Zeolites, 8, 446-448, 1988, disclose the preparation and characterization of zeolite beta, a large pore zeolite of *BEA framework type, which exhibits a three-dimensional pore system formed by 12-membered ring channels. Zeolite beta was first crystallized from a reaction mixture containing the tetraethylammonium ion (U.S. Pat. No. 3,308,069). U.S. Pat. No. 11,180,430 B2 discloses the preparation of zeolite beta, in particular zeolite beta having a high external surface area, using 1,1′-(pentane-1,5-diyl)bis(1-pentylpiperidinium) as structure directing agent, and its use in olefin oligomerization processes.

Despite these advances, there remains a need for new zeolites (or molecular sieves) with desirable properties as well as for new structure directing agents and for new or more efficient methods for the synthesis of new zeolites or of known zeolites with modified properties.

### SUMMARY

In a first aspect, the present disclosure relates to a method of making crystalline materials of *BEA framework type (or *BEA zeolite) . . . .

In a second aspect, the present disclosure relates to a crystalline material of *BEA framework type (or *BEA zeolite) having 1,1-(pentane-1,5-diyl)bis(1-propylpyrrolidinium) dication within its pore structure.

In a third aspect, the present disclosure relates to a crystalline material of BEA framework type (or *BEA zeolite) obtainable by the method disclosed herein.

In a fourth aspect, the present disclosure relates to a process of converting an organic compound to a conversion product, which comprises contacting the organic compound with the crystalline material according to any of the second or third aspect of the present disclosure, wherein part or all of the SDA has been removed.

These and other features and attributes of the present disclosure and their advantageous applications and/or uses will be apparent from the detailed description which follows. It will of course be appreciated that features described in relation to one aspect of the present invention may be incorporated into other aspects of the present invention. In particular, any two or more of the features described in this specification, including in this summary section, can be combined to form combinations of features not specifically described herein.

### DESCRIPTION OF THE DRAWINGS

FIG. 1 shows the powder XRD pattern of the as-synthesized product of Example 1.

FIG. 2 shows a SEM image of the as-synthesized product of Example 1.

FIG. 3 shows the powder XRD pattern of the as-synthesized product of Example 2.

FIG. 4 shows a SEM image of the as-synthesized product of Example 2.

FIG. 5 shows the powder XRD pattern of the as-synthesized product of Example 3.

FIG. 6 shows a SEM image of the as-synthesized product of Example 3.

FIG. 7 shows the powder XRD pattern of the as-synthesized product of Example 4.

FIG. 8 shows a SEM image of the as-synthesized product of Example 4.

FIG. 9 shows the powder XRD pattern of the as-synthesized product of Example 5.

FIG. 10 shows a SEM image of the as-synthesized product of Example 5.

FIG. 11 shows the powder XRD pattern of the as-synthesized product of Example 6.

FIG. 12 shows a SEM image of the as-synthesized product of Example 6.

FIG. 13 shows the powder XRD pattern of the as-synthesized product of Example 7.

FIG. 14 shows a SEM image of the as-synthesized product of Example 7.

### DETAILED DESCRIPTION

Described herein are methods of making crystalline materials of *BEA framework-type (or *BEA zeolite), in particular zeolite beta, crystalline materials of *BEA framework type obtainable therefrom and uses thereof.

In a first aspect, the present disclosure relates to a method of making crystalline materials of *BEA framework type (or *BEA zeolite) comprising the following steps:
(a) preparing a synthesis mixture comprising water, a source of an oxide of tetravalent element (Y), a source of an oxide of trivalent element (X), a structure directing agent (Q) comprising a 1,1-(pentane-1,5-diyl)bis(1-propylpyrrolidinium) dication, a source of hydroxide ions (OH), and optionally a source of alkali and/or alkaline earth metal element (M), said synthesis mixture having the following composition in terms of molar ratios:

| | |
|---|---|
| Y/X₂ | 10 to 200 |
| Q/Y | 0.01 to 1.0 |
| OH/Y | 0.05 to 1.5 |
| M/Y | 0 to 1.5 |
| H₂O/Y | 1 to 80 |

with the proviso that, when M/Y is 0.1 or less, Y/X₂ is less than 100,
(b) heating said synthesis mixture under crystallization conditions including a temperature of from 100 to 200° C. for a time sufficient to form crystals of said material;
(c) recovering at least a portion of the crystalline material from step (b); and
(d) optionally treating the crystalline material recovered in step (c) to remove at least part of the structure directing agent (Q).

While it is known that 1,1-(pentane-1,5-diyl)bis(1-propylpyrrolidinium) dication (or 1,5-bis(N-propylpyrrolidinium)pentane dication) can be used as a structure directing agent for the preparation of EMM-23 molecular sieve, as illustrated in International Application WO 2013/019462 A1, it has surprisingly been found that it can also be used for the preparation of crystalline materials of *BEA framework type, for instance of aluminosilicate crystalline materials (or zeolites) of *BEA framework type. This method is especially advantageous in that it allows for the preparation of crystalline materials of *BEA framework type through a synthesis route that can easily be scaled up. For instance, the method of the present disclosure allows for shorter crystallization times as compared to the method of U.S. Pat. No. 11,180,430 B2.

The structure directing agent (Q) comprises or is 1,1-(pentane-1,5-diyl)bis(1-propylpyrrolidinium) dication. The structure directing agent (Q) may be present in any suitable form, for example as a halide, such as a fluoride, a chloride, an iodide or a bromide, as a hydroxide or as a nitrate, for instance in its hydroxide form. The structure directing agent (Q) may be present in the synthesis mixture in a Q/Y molar ratio of 0.01 to 1.0, such as 0.05 to 0.8, or 0.1 to 0.7, for instance 0.1 to 0.5, e.g., 0.2 or 0.3.

The synthesis mixture comprises at least one source of an oxide of tetravalent element Y which may be selected from the group consisting of Si, Ge, Sn, Ti, Zr, and mixtures thereof, preferably Y comprises Si and/or Ge, e.g., Si, and more preferably Y is Si and/or Ge, e.g., Si. Suitable sources of tetravalent element Y that can be used to prepare the synthesis mixture depend on the element Y that is selected. In embodiments where Y is silicon, Si sources (e.g., silicon oxide sources) suitable for use in the method include silicic acids (e.g., SiO₂·nH₂O) such as Silicic Acid n-Hydrate (available from JT Baker®), silicates, e.g., tetraalkyl orthosilicates such as tetramethylorthosilicate (TMOS) and tetraethylorthosilicate (TEOS), or alkali metal silicates such as potassium silicate and sodium silicate, fumed silica such as Aerosil® (available from Evonik), Cabosperse® (available from Cabot) and CabO—O-Sil® (available from DMS), precipitated silica such as Ultrasil® and Sipernat® 340 (available from Evonik) or Hi-Sil®, and aqueous colloidal suspensions of silica, for example, that sold by Grace under the tradename Ludox® or that sold by Evonik under the tradename Aerodisp®; preferably silicic acids and silicates such as tetraalkyl orthosilicates. In embodiments where Y is germanium, suitable Ge sources include germanium oxide. In embodiments where Y is titanium, suitable Ti sources include titanium dioxide and titanium tetraalkoxides, such as titanium (IV) tetraethoxide and titanium (IV) tetrachloride. In embodiments where Y is tin, suitable Sn sources include tin chloride and tin alkoxides, such as tin ethoxide and tin isopropoxide. In embodiments where Y is zirconium, suitable Zr sources include zirconium chloride and zirconium alkoxides, such as zirconium ethoxide and zirconium isopropoxide.

The synthesis mixture comprises at least one source of an oxide of trivalent element X which may be selected from the group consisting of Al, B, Fe, Ga, and mixtures thereof, preferably X comprises Al and/or B, e.g., Al, and more preferably X is Al and/or B, e.g., Al. Suitable sources of trivalent element X that can be used to prepare the synthesis mixture depend on the element X that is selected. In embodiments where X is aluminum, Al sources (e.g., aluminum oxide sources) suitable for use in the method include aluminum hydroxide, aluminum salts, especially water-soluble salts, such as aluminum nitrate, aluminum sulfate, alkali metal aluminates such as sodium aluminate, and aluminum alkoxides such as aluminum isopropoxide, as well as hydrated aluminum oxides, such as boehmite, gibbsite, and pseudoboehmite, and mixtures thereof. Other aluminum sources include aluminum metal, such as aluminum in the form of chips. Especially suitable sources of alumina are aluminum hydroxide and water-soluble salts, such as aluminum nitrate, aluminum sulfate, and alkali metal aluminates such as sodium aluminate and potassium aluminate. In embodiments where X is boron, suitable B sources include boric acid and borate salts such as sodium tetraborate or borax and potassium tetraborate. Sources of boron tend to be more soluble than sources of aluminum in hydroxide-mediated synthesis systems. In embodiments where X is gallium, suitable Ga sources include sodium gallate, potassium gallate, and gallium salts such as gallium chloride, gallium sulfate, and gallium nitrate. In embodiments where X is iron, suitable Fe sources include iron chloride, iron nitrate, and iron oxides.

Alternatively or in addition to previously mentioned sources of Y and X, sources containing both Y and X elements can also be used, such as sources of Si and Al. Examples of suitable sources containing both Si and Al elements include amorphous silica-alumina gels or dried silica alumina powders, silica aluminas, clays, such as kaolin, metakaolin, and zeolites, in particular aluminosilicates such as synthetic faujasite and ultrastable faujasite, for instance Y-Type Zeolite, Ultrastable Y (USY), beta or other large to medium pore molecular sieves or zeolites.

The synthesis mixture may have a Y/X₂ molar ratio of from 10 to 200, such as 20 to 150, for instance 30 to 100, in particular 30 to less than 100, e.g., 30, 50 or 75.

In preferred embodiment of this aspect of the invention, Y is Si, X is Al, and the

The synthesis mixture comprises at least one source of hydroxide ions (OH). For example, hydroxide ions can be present as a counter ion of the structure directing agent (Q) or by the use of aluminum hydroxide or sodium aluminate as a source of Al. Suitable sources of hydroxide ions can also be selected from the group consisting of alkali metal hydroxides, alkaline earth metal hydroxides, ammonium hydroxide, and mixtures thereof; such as from sodium hydroxide, potassium hydroxide, lithium hydroxide, rubidium hydroxide, calcium hydroxide, magnesium hydroxide, ammonium hydroxide, and mixtures thereof; more often sodium hydroxide, potassium hydroxide, lithium hydroxide, ammonium hydroxide, and mixtures thereof; most often sodium hydroxide and/or potassium hydroxide. The synthesis mixture may comprise the hydroxide ions source in an OH/Y molar ratio of from 0.05 to 1.5, such as 0.1 to 1.0, or 0.2 to 0.9, e.g., 0.3, 0.4 or 0.5 to 0.8.

Optionally, the synthesis mixture may comprise one or more sources of alkali or alkaline earth metal cation (M). If present, M is preferably selected from the group consisting of sodium, potassium, lithium, rubidium, calcium, magnesium, strontium, barium, and mixtures thereof, preferably sodium and/or potassium, more preferably sodium. The sodium source, when present, may be sodium hydroxide, sodium aluminate, sodium silicate, sodium aluminate or sodium salts such as NaCl, NaBr or sodium nitrate. The potassium source, when present, may be potassium hydroxide, potassium aluminate, potassium silicate, a potassium salt such as KCl or KBr or potassium nitrate. The lithium source, when present, may be lithium hydroxide or lithium salts such as LiCl, LiBr, LiI, lithium nitrate. or lithium sulfate. The rubidium source, when present, may be rubidium hydroxide or rubidium salts such as RbCl, RhBr, Rbl or rubidium nitrate. The calcium source, when present, may be calcium hydroxide. The magnesium source, when present, may be magnesium hydroxide. The strontium source, when present, may be strontium hydroxide. The barium source, when present, may be barium hydroxide. The alkali or alkaline earth metal cation M may also be present in the one or more sources of a trivalent element X, such as sodium aluminate, sodium tetraborate, potassium tetraborate, sodium gallate, potassium gallate, and/or in the one or more sources of tetravalent element Y, such as potassium silicate and/or sodium silicate. The source of alkali or alkaline earth metal cation (M) is advantageously soluble in water. The synthesis mixture may comprise the alkali or alkaline earth metal cation (M) source in a M/Y molar ratio of 0 to 1.5, such as (if present) 0.05 to 1.0, in particular 0.05 or 0.1 to 0.8, e.g., 0.1 to 0.5. Alternatively, the synthesis mixture may be substantially free from alkali or alkaline earth metal cation (M). When the synthesis mixture comprises the alkali or alkaline earth metal cation (M) source in a M/Y molar ratio of 0.1 or less, for instance when the synthesis mixture is substantially free from alkali or alkaline earth metal cation (M), it has been found that the synthesis mixture should have a Y/X₂ molar ratio of less than 100, such as at most 95, e.g., at most 85 or 75.

The synthesis mixture is preferably substantially free of fluoride ions (F). This means that no source of fluoride ions is added to the synthesis mixture in any substantial amount, e.g., the synthesis mixture has a F/Y molar ratio of less than 0.05, in particular less than 0.01 or even less than 0.005, such as 0. Small amounts of fluoride ions (F) may be present as impurities, for instance in the optional source of alkali or alkaline earth metal cation (M).

The synthesis mixture may optionally contain at least one source of halide ions (W), different from fluoride ions, which may be selected from the group consisting of chloride, bromide or iodide. The source of halide ions (W) may be any compound capable of releasing halide ions in crystalline material synthesis mixture. For instance, halide ions can be present as a counter ion of the structure directing agent (Q). Non-limiting examples of sources of halide ions include hydrogen chloride, ammonium chloride, hydrogen bromide, ammonium bromide, hydrogen iodide, and ammonium iodide; salts containing one or several halide ions, such as metal halides, preferably where the metal is an alkali or alkaline earth metal such as sodium, potassium, calcium, magnesium, strontium or barium; or tetraalkylammonium halides such as tetramethylammonium halides or tetraethylammonium halides. Small amounts of halide ions (W) may also be present as impurities, for instance in the optional source of alkali or alkaline earth metal cation (M). The halide ions (W) may be present in a W/Y molar ratio of 0 to 0.2, such as 0 to 0.1, for instance less than 0.1 or even 0. Alternatively, the synthesis mixture may be substantially free from halide ions (W).

The synthesis may be performed with or without added nucleating seeds. If nucleating seeds are added to the synthesis mixture, the seeds may be of the same or of a different structure than the crystalline material of the present disclosure, but preferably crystalline materials of *BEA framework type, for instance conventional zeolite beta or *BEA zeolite obtained from the present synthesis. Nucleating seeds may suitably present in an amount from about 0.01 ppm by weight to about 10,000 ppm by weight, based on the synthesis mixture, such as from about 100 ppm by weight to about 5,000 ppm by weight of the synthesis mixture.

The synthesis mixture typically comprises water in a H₂O/Y molar ratio of from 1 to 80, in particular 3 to 50 or 4 to 40, such as 5 to 10 or 10 to 30, e.g., 5 to less than 10 or 10 to 20. Depending on the nature of the components in the base mixture, the amount of solvent (e.g., water from the hydroxide solution, and optionally methanol and ethanol from the hydrolysis of silica sources) of the base mixture may be removed such that a desired solvent to Y molar ratio is achieved for the synthesis mixture. Suitable methods for reducing the solvent content may include evaporation under a static or flowing atmosphere such as ambient air, dry nitrogen, dry air, or by spray drying or freeze drying. Water may also be added to the resulting mixture to achieve the desired H₂O/Y molar ratio when too much water is removed during the solvent removal process. In some examples, water removal is not necessary when the preparation have sufficient H₂O/Y molar ratio.

The synthesis mixture may have a OH/H₂O molar ratio of less than 0.1, in particular from 0.01 to less than 0.1, such as 0.015 to 0.08 or 0.02 to less than 0.06, e.g., 0.03, 0.04, 0.05 or 0.06.

Carbon in the form of CH₂ may be present in the various sources of components used to prepare the synthesis mixture of the present disclosure, e.g., tetravalent element source (silica source) or trivalent element source (alumina source), and incorporated into the resulting crystalline material as bridging atoms. Nitrogen atoms may be incorporated into the framework of the crystalline material as bridging atoms after the SDA has been removed.

In one or more aspects, the synthesis mixture after solvent adjustment (e.g., where the desired water to silica ratio is achieved) may be mixed by a mechanical process such as stirring or high shear blending to assure suitable homogenization of the base mixture, for example, using dual asymmetric centrifugal mixing (e.g., a FlackTek speedmixer) with a mixing speed of 1000 to 3000 rpm (e.g., 2000 rpm).

The synthesis mixture is then subject to crystallization conditions suitable for the crystalline material to form. Crystallization of the material may be carried out under static or stirred conditions in a suitable reactor vessel, such as for example, Teflon® lined or stainless steel autoclaves placed in a convection oven maintained at an appropriate temperature.

The crystallization in step (b) of the method is typically carried out at a temperature of 100° C. to 200° C., such as 120° C. to 180° C., preferably 130° C. to 170° C., e.g., 140 to 160° C., for a time sufficient for crystallization to occur at the temperature used. For instance, at higher temperatures, the crystallization time may be reduced. For instance, the crystallization conditions in step (b) of the method may include heating for a period of from 1 to 50 days, such as 1 to 30 or 2 to 20 days, in particular from 2 to less than 10 days, e.g., about 3 to 7 or even 5 days. The crystallization time can be established by methods known in the art such as by sampling the synthesis mixture at various times and determining the yield and X-ray crystallinity of precipitated solid. Unless indicated otherwise herein, the temperature measured is the temperature of the surrounding environment of the material being heated, for example the temperature of the atmosphere in which the material is heated.

Typically, the crystalline material is formed in solution and can be recovered by standard means, such as by centrifugation or filtration. The separated crystalline material can also be washed, recovered by centrifugation or filtration and dried.

The crystalline material of the present disclosure, when employed either as an adsorbent or as a catalyst in an organic compound conversion process may be dehydrated (e.g., dried) at least partially. This can be done by heating to a temperature in the range of 80° C. to 500° C., such as 90° C. to 370° C. in an atmosphere such as air, nitrogen, etc., and at atmospheric, subatmospheric or superatmospheric pressures for between 30 minutes and 48 hours. Dehydration may also be performed at room temperature merely by placing the crystalline material in a vacuum, but a longer time is required to obtain a sufficient amount of dehydration.

As a result of the crystallization process, the recovered product contains within its pores at least a portion of the structure directing agent used in the synthesis. The as-synthesized crystalline material recovered from step (c) may thus be subjected to thermal treatment or other treatment to remove part or all of the SDA incorporated into its pores during the synthesis. Thermal treatment (e.g., calcination) of the as-synthesized crystalline material typically exposes the materials to high temperatures sufficient to remove part or all of the SDA, in an atmosphere selected from air, nitrogen, ozone or a mixture thereof in a furnace. While subatmospheric pressure may be employed for the thermal treatment, atmospheric pressure is desired for reasons of convenience. The thermal treatment may be performed at a temperature up to 925° C. e.g., 300° C. to 700° C. or 400 to 600° C. The temperature measured is the temperature of the surrounding environment of the sample. The thermal treatment (e.g., calcination) may be carried out in a box furnace in dry air, which has been exposed to a drying tube containing drying agents that remove water from the air. The material is usually calcined for at least 1 minute and generally no longer than 1 or at most a few days. The heating may first be carried out under a nitrogen atmosphere and then the atmosphere may be switched to air and/or ozone.

The crystalline material may also be subjected to an ion-exchange treatment, for example, with aqueous ammonium salts, such as ammonium nitrates, ammonium chlorides, and ammonium acetates, in order to remove remaining alkali metal cations and/or alkaline earth metal cations, if present in the synthesis mixture, and to replace them with protons thereby producing the acid form of the crystalline material. To the extent desired, the original cations of the as-synthesized material, such as alkali metal cations, can be replaced by ion exchange with other cations. Preferred replacing cations can include hydrogen ions, hydrogen precursor, e.g., ammonium ions and mixtures thereof. The ion exchange step may take place after the as-made crystalline material is dried. The ion-exchange step may take place either before or after a calcination step.

The crystalline material may also be subjected to other treatments such as steaming and/or washing with solvent. Such treatments are well-known to the skilled person and are carried out in order to modify the properties of the crystalline material as desired.

In a second aspect, the present disclosure relates to a crystalline material of *BEA framework type (or *BEA zeolite) having 1,1-(pentane-1,5-diyl)bis(1-propylpyrrolidinium) dication within its pore structure. Said crystalline material may be represented by the molecular formula of Formula I:

(q)Q:(m)X₂O₃:YO₂ (Formula I),

wherein 0<q≤1.0, 0.01<m≤0.1, X is a trivalent element, Y is a tetravalent element, and Q is 1,1-(pentane-1,5-diyl)bis(1-propylpyrrolidinium) dication. Y may be selected from Si, Ge, Sn, Ti, Zr, and mixtures thereof. For example, Y may comprise Si and/or Ge, e.g., Si, in particular Y may be Si and/or Ge, e.g., Si. X may be selected from the group consisting of Al, B, Fe, Ga, and mixtures thereof. For instance, X may comprise Al and/or B, e.g., Al, in particular X may be Al and/or B, e.g., Al. In embodiments where Y is Si and X is Al, the crystalline material is an aluminosilicate. The oxygen atoms in Formula I may be replaced by carbon atoms (e.g., in the form of CH₂), which can come from sources of the components used to prepare the as-made crystalline material. The oxygen atoms in Formula I can also be replaced by nitrogen atoms, e.g., after the SDA has been removed. Formula I can represent the framework of a typical crystalline material of *BEA framework type having structure directing agent (Q) within its pore structure and is not meant to be the sole representation of such material. The crystalline material may contain impurities which are not accounted for in Formula I. Further, Formula I does not include the protons and charge compensating ions that may be present in the crystalline material.

The variable m represents the molar ratio relationship of X₂O₃ to YO₂ in Formula I. For example, when m is 0.01, the molar ratio of YO₂ to X₂O₃ is 100 (e.g., the molar ratio of Si/Al₂ is 100). m may be at most 0.1 and at least 0.01, such as at least 0.02, 0.025, 0.033, e.g., from 0.04 or from more than 0.04 to 0.1 or to 0.07. The molar ratio YO₂ to X₂O₃ may be at least 10 and up to 100, in particular up to 50, such as up to 40 or up to 30, e.g., 10 or 15 to 25 or to less than 25.

The variable q represents the molar relationship of Q to YO₂ in Formula I. For example, when q is 0.1, the Q/Y molar ratio is 0.1. The molar ratio of Q to YO₂ may be from more than 0 to 1.0, such as from 0.05 to 0.8, or 0.1 to 0.7, e.g., 0.1 to 0.5.

In a third aspect, the present disclosure relates to a crystalline material of BEA framework type (or *BEA zeolite) obtainable by (or obtained by) the method of the first aspect disclosed herein. Said crystalline material, in its as-synthesized form, may be represented by the molecular formula of Formula I, as defined for the second aspect of the present disclosure. Said crystalline material, in its calcined form (e.g., where at least part of the SDA has been removed via thermal treatment or other treatment), may be represented by the molecular formula of Formula II:

(m)X₂O₃:YO₂ (Formula II),

wherein m, X and Y are as defined as in Formula I. The oxygen atoms in Formula II may be replaced by carbon atoms (e.g., in the form of CH₂), which can come from sources of the components used to prepare the as-made crystalline material. The oxygen atoms in Formula II can also be replaced by nitrogen atoms, e.g., after the SDA has been removed. Formula II can represent the framework of a typical crystalline material of *BEA framework type as defined in the present disclosure, in its calcined form, and is not meant to be the sole representation of said crystalline material. Said crystalline material, in its calcined form, may contain SDA and/or impurities after appropriate treatments to remove the SDA and impurities, which are not accounted for in Formula II. Further, Formula II does not include the protons and charge compensating ions that may be present in the calcined crystalline material.

The crystalline material of the present disclosure, in its calcined form, may have a total surface area (TSA) of at least 500 m²/g, such as at least 600 m²/g, and of at most 900 m²/g, such as at most 800 m²/g; and/or an external surface area (ESA) of at least 150 m²/g, such as at least 200 m²/g, and of at most 600 m²/g, such as at most 500 m²/g. Advantageously, said crystalline material, in its calcined form, may have a ratio of external surface area to total surface area (ESA/TSA) of from 0.2 to 0.8, such as from 0.3 to 0.7, e.g., 0.4, 0.5, or 0.6.

The crystalline material of *BEA framework type of the second and third of the present disclosure, where part or all of the SDA has been removed, may be used as an adsorbent or as a catalyst or support for catalyst in a wide variety of hydrocarbon conversions, e.g., conversion of organic compounds to a converted product. In a fourth aspect, the present disclosure therefore relates to a process of converting an organic compound to a conversion product, which comprises contacting the organic compound with the crystalline material of the second or third aspect of the present disclosure, wherein part or all of the SDA has been removed.

The crystalline materials of the present disclosure (where part or all of the SDA is removed) may be used as an adsorbent, such as for separating at least one component from a mixture of components in the vapor or liquid phase having differential sorption characteristics with respect to the material. Therefore, at least one component can be partially or substantially totally separated from a mixture of components having differential sorption characteristics with respect to the crystalline material by contacting the mixture with said crystalline material to selectively sorb the one component. For instance, in a process for selectively separating one or more desired components of a feedstock from remaining components of the feedstock, the feedstock may be contacted with a sorbent that comprises the crystalline material of the present disclosure at effective sorption conditions, thereby forming a sorbed product and an effluent product. One or more of the desired components are recovered from either the sorbed product or the effluent product. Examples of adsorption processes include reactive guard bed applications to remove poisons from feeds, for instance into alkylation units, and adsorption of aromatics from lubes feeds.

The crystalline material of the present disclosure (where part or all of the SDA is removed) may also be used as a catalyst to catalyze a wide variety of organic compound conversion processes. Examples of chemical conversion processes, which are effectively catalyzed by the crystalline material described herein, either alone or in combination with one or more other catalytically active substances including other crystalline catalysts, include those requiring a catalyst with acid activity. Examples of organic conversion processes, which may be catalyzed by the crystalline material described herein, either alone or in combination with one or more other catalytically active substances, including other crystalline catalysts, include cracking, including cracking applied to polyolefin decomposition, hydrocracking, isomerization, including mild cracking of fuels, lubes and LEF products, polymerisation, reforming, hydrogenation, dehydrogenation, dewaxing, hydrodewaxing, adsorption, alkylation, transalkylation, dealkylation, hydrodecylization, disproportionation, oligomerization, in particular olefin oligomerization, dehydrocyclization, conversion of methanol to olefins, deNOx applications, and combinations thereof. The conversion of hydrocarbon feeds can take place in any convenient mode, for example in fluidized bed, moving bed, or fixed bed reactors depending on the types of process desired.

The crystalline material of the present disclosure may be formulated into product compositions by combination with other materials, such as binders and/or matrix materials that provide additional hardness to the finished product. These other materials can be inert or catalytically active materials.

For instance, it may be desirable to incorporate the crystalline material of the present disclosure with another material that is resistant to the temperatures and other conditions employed during use. Such materials include synthetic or naturally occurring zeolites as well as inorganic materials such as clays, silica and/or metal oxides such as alumina and mixtures thereof. The metal oxides may be either naturally occurring or in the form of gelatinous precipitates or gels including mixtures of silica and metal oxides. Use of a resistant material in conjunction with the crystalline material of the present disclosure, i.e., combined therewith or present during synthesis of the as-made crystalline material, which crystal is active, tends to change the conversion and/or selectivity of the catalyst in certain organic conversion processes. Inactive resistant materials suitably serve as diluents to control the amount of conversion in a given process so that products can be obtained in an economic and orderly manner without employing other means for controlling the rate of reaction. These materials may be incorporated into naturally occurring clays, e.g., bentonite and kaolin, to improve the crush strength of the product under commercial operating conditions. Said inactive resistant materials, i.e., clays, oxides, etc., function as binders for the catalyst. A catalyst having good crush strength can be beneficial because in commercial use, it is desirable to prevent the catalyst from breaking down into powder-like materials.

Naturally occurring clays which may be used include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays can be used in the raw state as originally mined or after being subjected to calcination, acid treatment or chemical modification.

Binders useful for compositing with the crystalline material of the present disclosure also include inorganic oxides selected from silica, zirconia, titania, magnesia, beryllia, alumina, yttria, gallium oxide, zinc oxide and mixtures thereof. In addition to the foregoing materials, the crystalline material of the present disclosure may be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

These binder materials are resistant to the temperatures and other conditions, e.g., mechanical attrition, which occur in various hydrocarbon separation processes. Thus the crystalline material of the present disclosure may be used in the form of an extrudate with a binder. They are typically bound by forming a pill, sphere, or extrudate. The extrudate is usually formed by extruding the crystalline material, optionally in the presence of a binder, and drying and calcining the resulting extrudate. Further treatments such as steaming, and/or ion exchange may be carried out as required. The crystalline material may optionally be bound with a binder having a surface area of at least 100 m²/g, for instance at least 200 m²/g, optionally at least 300 m²/g. The relative proportions of crystalline material and inorganic oxide matrix may vary widely, with the crystalline material content ranging from about 1 to about 100 percent by weight and more usually, particularly when the composite is prepared in the form of extrudates, in the range of about 2 to about 95, optionally from about 20 to about 90 weight percent of the composite.

The crystalline material of the present disclosure may also be used in intimate combination with a hydrogenating component such as tungsten, vanadium, molybdenum, rhenium, nickel, cobalt, chromium, manganese, or a noble metal such as platinum or palladium where a hydrogenation-dehydrogenation function is to be performed. Such hydrogenating components may be incorporated in the composition by way of one or more of the following processes: cocrystallization; exchanged into the composition to the extent a Group IIIA element, e.g., aluminum, is in the structure; or intimately physically admixed therewith. Such components can also be impregnated in or onto the crystalline material, for example, by treating the crystalline material with a hydrogenating metal-containing ion. For instance, in the case of platinum, suitable platinum compounds for this purpose include chloroplatinic acid, platinous chloride and various compounds containing a platinum amine complex. Combinations of metals and methods for their introduction can also be used.

It will be understood by a person skilled in the art that the crystalline material of the present disclosure may contain impurities, such as amorphous materials, unit cells having different topologies (e.g., quartz or molecular sieves or zeolites of different framework type, that may or may not impact the performance of the resulting catalyst), and/or other impurities (e.g., heavy metals and/or organic hydrocarbons). Typical examples of molecular sieves or zeolites of different framework type co-existing with the crystalline material of the present disclosure are e.g., EMM-23. The crystalline material of the present disclosure is preferably substantially free of impurities. The term “substantially free of impurities” (or in the alternative “substantially pure”) used herein means the crystalline material contains a minor proportion (less than 50 wt %), preferably less than 20 wt %, more preferably less than 10 wt %, even more preferably less than 5 wt % and most preferably less than 1 wt % (e.g., less than 0.5 wt % or 0.1 wt %), of such impurities (or “non-*BEA” framework type or “non-zeolite beta” material), which weight percent (wt %) values are based on the combined weight of impurities and pure crystalline material. The amount of impurities can be appropriately determined by powder XRD, rotating electron diffraction, and/or SEM/TEM (e.g., different crystal morphologies).

The crystalline material described herein is substantially crystalline. As used herein, the term “crystalline” refers to a crystalline solid form of a material, including, but not limited to, a single-component or multiple-component crystal form, e.g., including solvates, hydrates, and a co-crystal. Crystalline can mean having a regularly repeating and/or ordered arrangement of molecules, and possessing a distinguishable crystal lattice. For example, the crystalline material can have different water or solvent content. The different crystalline lattices can be identified by solid state characterization methods such as by XRD (e.g., powder XRD). Other characterization methods known to a person of ordinary skill in the relevant art can further help identify the crystalline form as well as help determine stability and solvent/water content. As used herein, the term “substantially crystalline” means a majority (greater than 50 wt %) of the weight of a sample of a material described is crystalline and the remainder of the sample is a non-crystalline form. In one or more aspects, a substantially crystalline sample has at least 95% crystallinity (e.g., 5% of the non-crystalline form), at least 96% crystallinity (e.g., 4% of the non-crystalline form), at least 97% crystallinity (e.g., 3% of the non-crystalline form), at least 98% crystallinity (e.g., about 2% of the non-crystalline form), at least 99% crystallinity (e.g., 1% of the non-crystalline form), and 100% crystallinity (e.g., 0% of the non-crystalline form).

Aspects of the disclosure are described in greater detail by way of specific examples. The following examples are offered for illustrative purposes and are not intended to limit the disclosure in any manner. Those of skill in the relevant art will readily recognize a variety of parameters can be changed or modified to yield essentially the same results.

### EXAMPLES

The present invention is further illustrated below without limiting the scope thereto.

In these examples, the X-ray diffraction (XRD) patterns of the as-synthesized and calcined materials were recorded on an X-Ray Powder Diffractometer (Bruker D8 Discover) in continuous mode using a Cu Kα radiation, Bragg-Bentano geometry with Lynxeye detector, in the 20 range of 4 to 70 degrees. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history.

The scanning electron microscopy (SEM) images of the as-synthesized materials were obtained on a FEI Helios Nanolab G3 UC FIB/FEG SEM. SEM images were used to aid assessment of product purity. The presence of obviously different crystal morphologies in a SEM image can be an indication of impurities in the form of other crystalline materials. Such an approximate analysis can be especially useful in identifying the presence of formation of relatively minor amounts of crystalline impurities which may not be identifiable on product XRD patterns.

The following measurements were conducted on samples that were calcined at 500° C. for 16 hours.

The total surface area (TSA) of the materials was determined by the BET method as described by S. Brunauer, P. H. Emmett and E. Teller, J. Am. Chem. Soc., 1938, 60, 309, incorporated herein by reference, using nitrogen adsorption-desorption at liquid nitrogen temperature. The external surface area (ESA) of the material was obtained from the t-plot method, and the micropore surface area (MSA) of the material was calculated by subtracting the external surface area (ESA) from the total surface area (TSA).

### Example 1: Synthesis of *BEA Zeolite from Silicic Acid and Aluminum Nitrate, Si/Al₂=150

0.2464 g aluminum nitrate nonahydrate, 0.6233 g water, 2.8968 g of a sodium hydroxide solution (20 wt %), 17.8008 g of a 1,1-(pentane-1,5-diyl)bis(1-propylpyrrolidinium) hydroxide solution (22.41 w %) and 3.4157 g silicic acid (JT Baker®0324-05 Silicic Acid, n-Hydrate, Powder) were added to a Teflon liner. The mixture was stirred for 5 min after each addition and for 15 min after the last addition, to produce a synthesis mixture having the following composition in terms of molar ratios:

1SiO₂:0.0067Al₂O₃:0.25QOH:0.30NaOH:20H₂O

The synthesis mixture was treated under the following hydrothermal conditions without stirring: heat-up rate as fast as possible, synthesis temperature of 150° C., soak time of 72 hours. The solid material was recovered afterwards by centrifugation, washed several times with water and dried at 120° C.

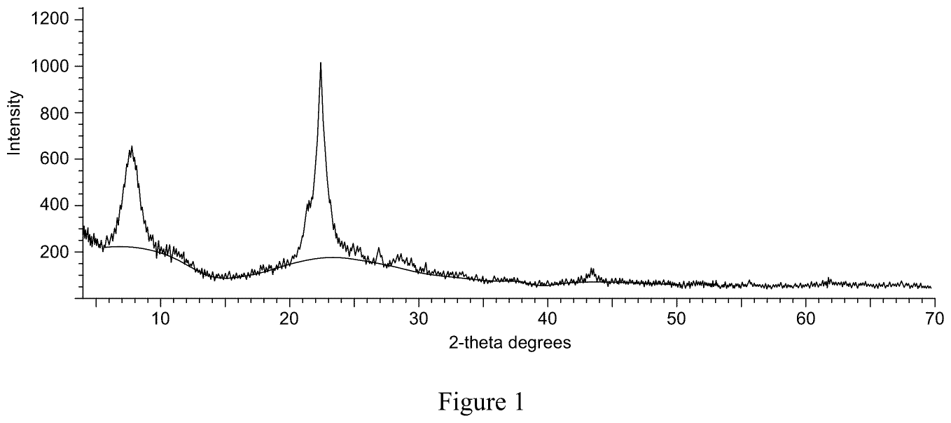

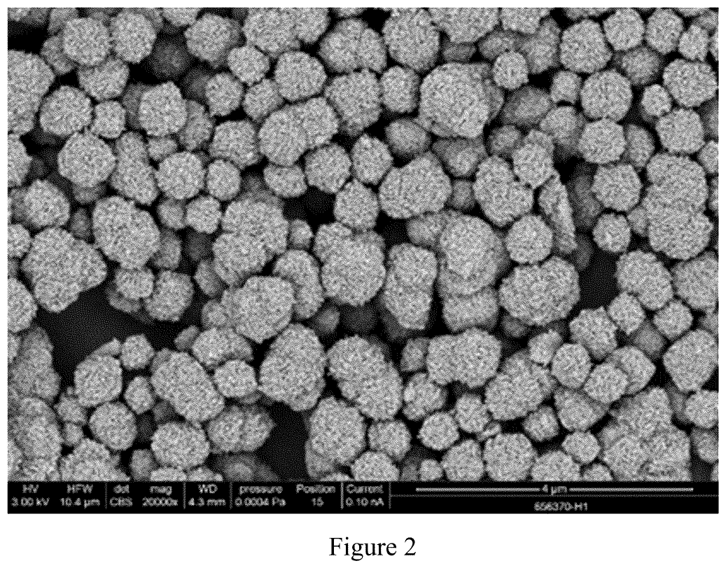

XRD analysis of the as-synthesized product, illustrated in FIG. 1, showed the crystalline material to be of *BEA framework type. FIG. 2 shows a SEM image of the as-synthesized crystalline material of Example 1. Inductively coupled plasma (ICP) analysis indicated the product had a Si/Al₂ molar ratio of 13.5.

The total surface area (TSA) of the calcined version of the crystalline material of Example 1 was 716.6 m²/g, its external surface area (ESA) was 353.8 m²/g, its micropore surface area (MSA) was 362.8 m²/g, and the ratio TSA/ESA was 0.50.

### Example 2: Synthesis of *BEA Zeolite from Silicic Acid and Sodium Aluminate, Si/Al₂=150

0.1952 g sodium aluminate solution (16.889 wt % Al₂O₃/12.285 wt % Na₂O in water), 1.9076 g water, 1.3154 g of a sodium hydroxide solution (20 wt %), 17.8804 g of a 1,1-(pentane-1,5-diyl)bis(1-propylpyrrolidinium) hydroxide solution (22.41 w %) and 3.5120 g silicic acid (JT Baker® 0324-05 Silicic Acid, n-Hydrate, Powder) were added to a Teflon liner. The mixture was stirred for 5 min after each addition and for 15 min after the last addition, to produce a synthesis mixture having the following composition in terms of molar ratios:

1SiO₂:0.0067Al₂O₃:0.25QOH:0.15NaOH:20H₂O

The synthesis mixture was treated under the following hydrothermal conditions without stirring: heat-up rate as fast as possible, synthesis temperature of 150° C., soak time of 72 hours. The solid material was recovered afterwards by centrifugation, washed several times with water and dried at 120° C.

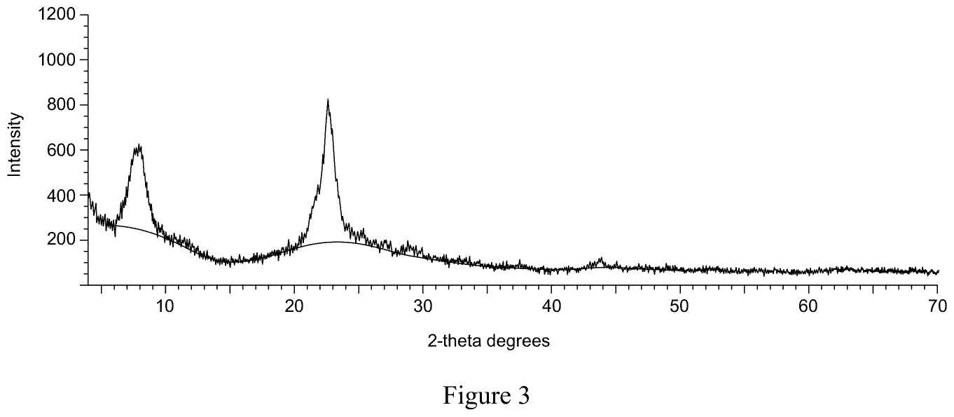

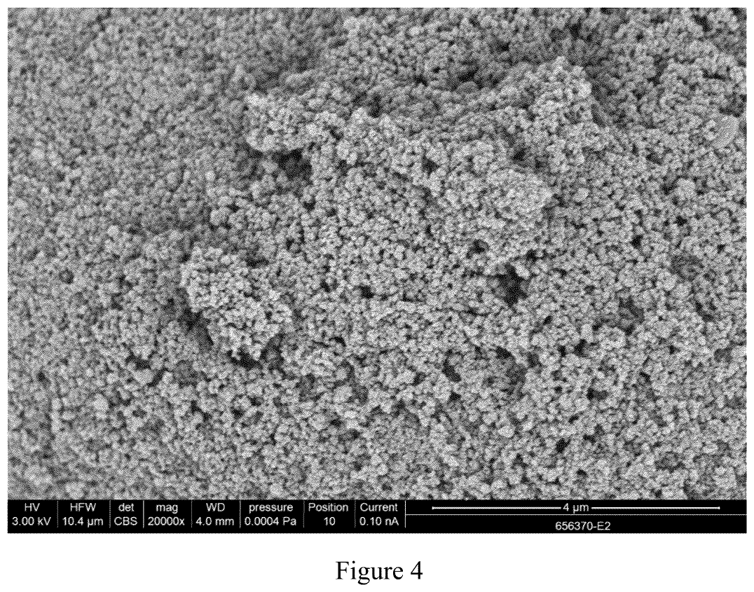

XRD analysis of the as-synthesized product, illustrated in FIG. 3, showed the crystalline material to be of *BEA framework type. FIG. 4 shows a SEM image of the as-synthesized crystalline material of Example 1. Inductively coupled plasma (ICP) analysis indicated the product had a Si/Al₂ molar ratio of 36.5.

The total surface area (TSA) of the calcined version of the crystalline material of Example 2 was 743.9 m²/g, its external surface area (ESA) was 356.8 m²/g, its micropore surface area (MSA) was 387.1 m²/g, and the ratio TSA/ESA was 0.48.

### Example 3: Synthesis of *BEA Zeolite from Silicic Acid and Aluminum Nitrate, Si/Al₂=75

0.2359 g aluminum nitrate nonahydrate, 0.7042 g water, 0.9638 g of a sodium hydroxide solution (30 wt %), 8.5051 g of a 1,1-(pentane-1,5-diyl)bis(1-propylpyrrolidinium) hydroxide solution (22.41 w %) and 1.6338 g silicic acid (JT Baker® 0324-05 Silicic Acid, n-Hydrate, Powder) were added to a Teflon liner. The mixture was stirred for 5 min after each addition and for 15 min after the last addition, to produce a synthesis mixture having the following composition in terms of molar ratios:

1SiO₂:0.0133Al₂O₃:0.25QOH:0.30NaOH:20H₂O

The synthesis mixture was treated under the following hydrothermal conditions without stirring: heat-up rate as fast as possible, synthesis temperature of 150° C., soak time of 72 hours. The solid material was recovered afterwards by centrifugation, washed several times with water and dried at 120° C.

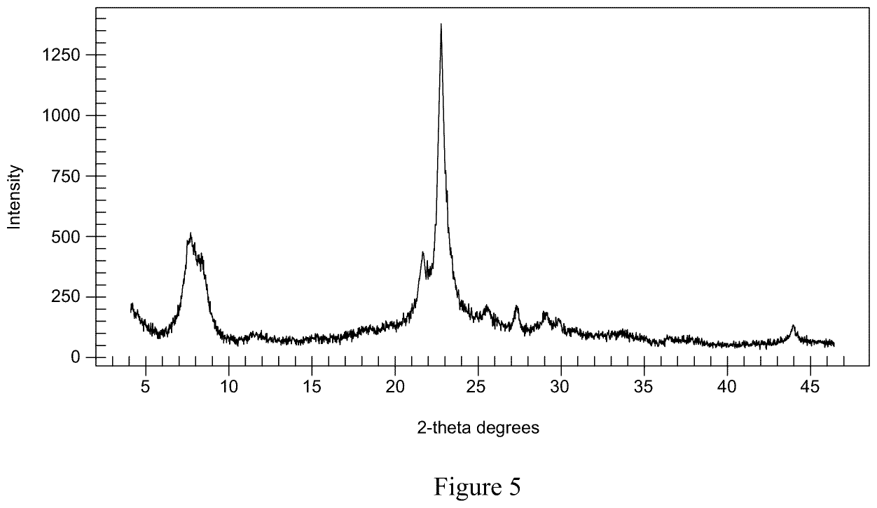

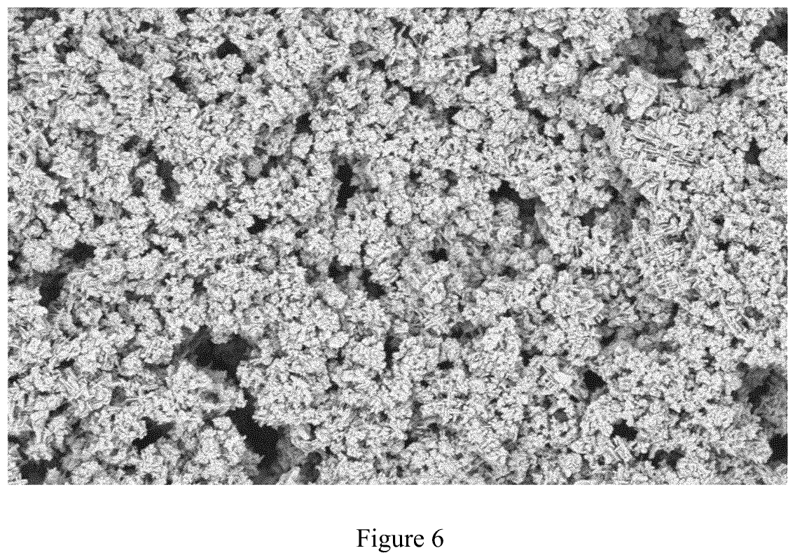

XRD analysis of the as-synthesized product, illustrated in FIG. 5, showed the crystalline material to be of *BEA framework type. FIG. 6 shows a SEM image of the as-synthesized crystalline material of Example 3. Inductively coupled plasma (ICP) analysis indicated the product had a Si/Al₂ molar ratio of 23.5.

The total surface area (TSA) of the calcined version of the crystalline material of Example 3 was 677.1 m²/g, its external surface area (ESA) was 254.5 m²/g, its micropore surface area (MSA) was 422.6 m²/g, and the ratio TSA/ESA was 0.38.

### Example 4: Synthesis of *BEA Zeolite from Silicic Acid and Aluminum Hydroxide, Si/Al₂=75

0.0761 g aluminum hydroxide (SigmaAldrich, 52 wt % Al₂O₃), 1.1551 g of a sodium hydroxide solution (30 wt %), 8.6889 g of a 1,1-(pentane-1,5-diyl)bis(1-propylpyrrolidinium) hydroxide solution (22.41 w %) and 2.0798 g silicic acid (JT Baker®0324-05 Silicic Acid, n-Hydrate, Powder) were added to a Teflon liner. The mixture was stirred for 5 min after each addition and for 15 min after the last addition, to produce a synthesis mixture having the following composition in terms of molar ratios:

1SiO₂:0.0133Al₂O₃:0.20QOH:0.30NaOH:15H₂O

The synthesis mixture was treated under the following hydrothermal conditions without stirring: heat-up rate as fast as possible, synthesis temperature of 150° C., soak time of 108 hours. The solid material was recovered afterwards by centrifugation, washed several times with water and dried at 120° C.

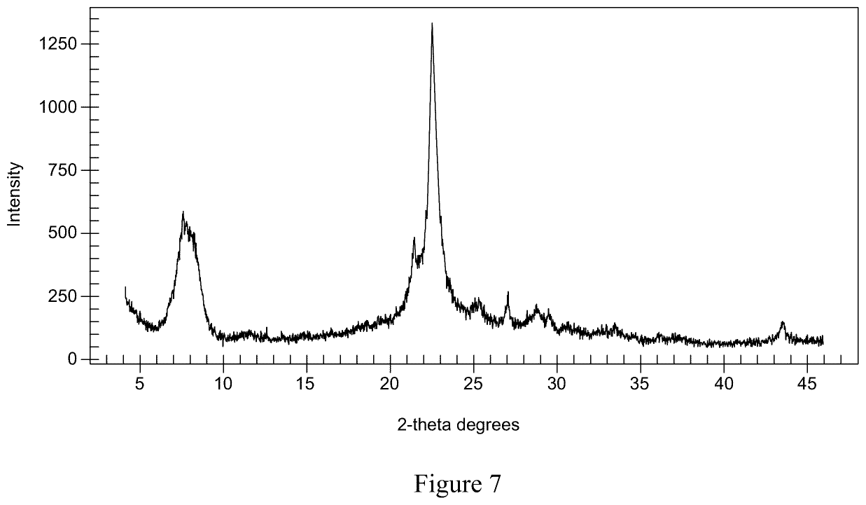

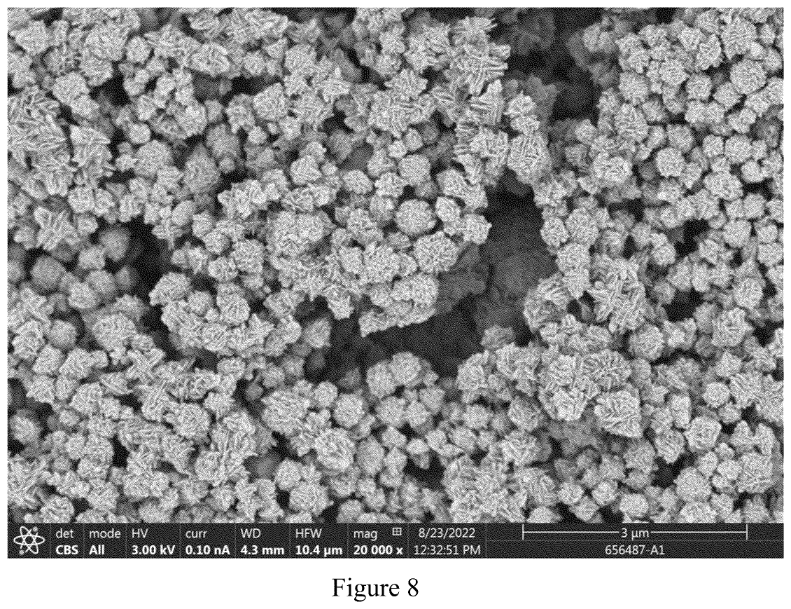

XRD analysis of the as-synthesized product, illustrated in FIG. 7, showed the crystalline material to be of *BEA framework type. FIG. 8 shows a SEM image of the as-synthesized crystalline material of Example 4. Inductively coupled plasma (ICP) analysis indicated the product had a Si/Al₂ molar ratio of 24.99.

The total surface area (TSA) of the calcined version of the crystalline material of Example 4 was 683.9 m²/g, its external surface area (ESA) was 273.1 m²/g, its micropore surface area (MSA) was 410.8 m²/g, and the ratio TSA/ESA was 0.40.

### Example 5: Synthesis of *BEA Zeolite from Silicic Acid and Aluminum Hydroxide, Si/Al₂=50

0.0761 g aluminum hydroxide (SigmaAldrich, 52 wt % Al₂O₃), 1.1551 g of a sodium hydroxide solution (30 wt %), 8.6889 g of a 1,1-(pentane-1,5-diyl)bis(1-propylpyrrolidinium) hydroxide solution (22.41 w %) and 2.0798 g silicic acid (JT Baker® 0324-05 Silicic Acid, n-Hydrate, Powder) were added to a Teflon liner. The mixture was stirred for 5 min after each addition and for 15 min after the last addition, to produce a synthesis mixture having the following composition in terms of molar ratios:

1SiO₂:0.02Al₂O₃:0.20QOH:0.18NaOH:13.4H₂O

The synthesis mixture was treated under the following hydrothermal conditions without stirring: heat-up rate as fast as possible, synthesis temperature of 150° C., soak time of 120 hours. The solid material was recovered afterwards by centrifugation, washed several times with water and dried at 120° C.

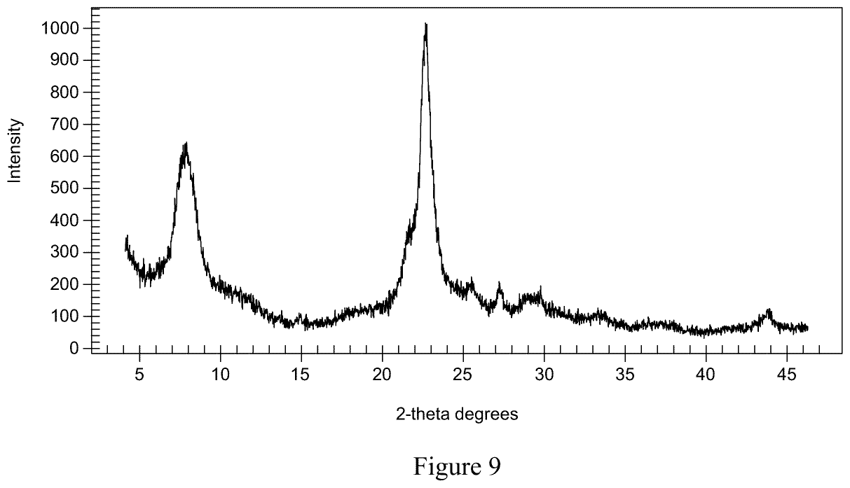

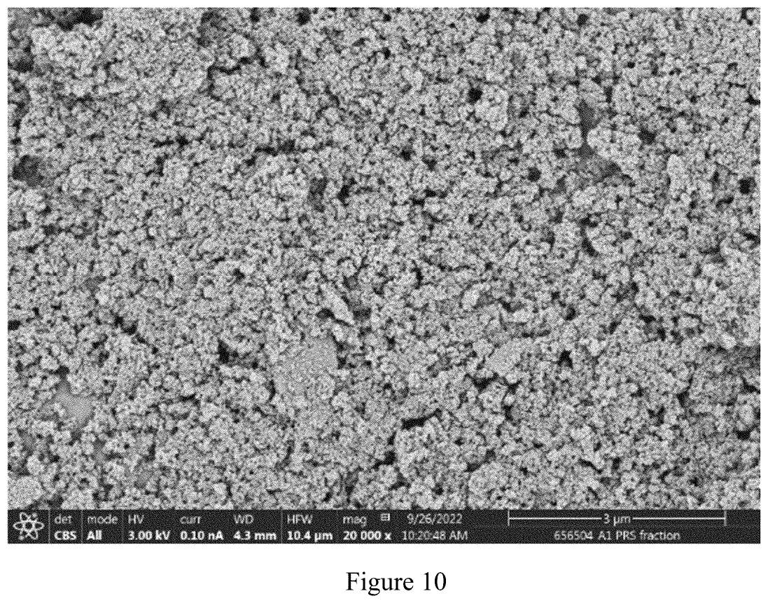

XRD analysis of the as-synthesized product, illustrated in FIG. 9, showed the crystalline material to be of *BEA framework type. FIG. 10 shows a SEM image of the as-synthesized crystalline material of Example 5. Inductively coupled plasma (ICP) analysis indicated the product had a Si/Al₂ molar ratio of 22.5.

The total surface area (TSA) of the calcined version of the crystalline material of Example 5 was 726.4 m²/g, its external surface area (ESA) was 325.6 m²/g, its micropore surface area (MSA) was 400.8 m²/g, and the ratio TSA/ESA was 0.45.

### Example 6: Synthesis of *BEA Zeolite from Silicic Acid and Aluminum Hydroxide, Si/Al₂=30

0.1689 g aluminum hydroxide (SigmaAldrich, 52 wt % Al₂O₃), 0.1865 g NaOH pellets, 7.4983 g of a 1,1-(pentane-1,5-diyl)bis(1-propylpyrrolidinium) hydroxide solution (22.41 w %) and 1.8212 g silicic acid (JT Baker® 0324-05 Silicic Acid, n-Hydrate, Powder) were added to a Teflon liner. The mixture was stirred for 5 min after each addition and for 15 min after the last addition, to produce a synthesis mixture having the following composition in terms of molar ratios:

1SiO₂:0.033Al₂O₃:0.20QOH:0.18NaOH:13.5H₂O

The synthesis mixture was treated under the following hydrothermal conditions without stirring: heat-up rate as fast as possible, synthesis temperature of 150° C., soak time of 168 hours. The solid material was recovered afterwards by centrifugation, washed several times with water and dried at 120° C.

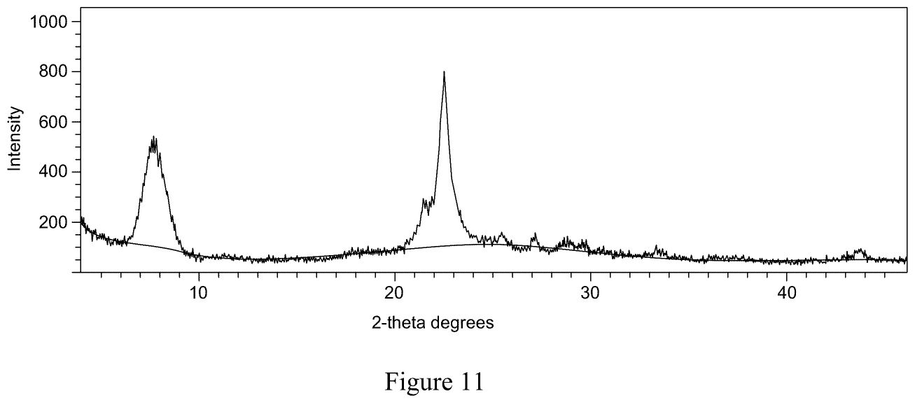

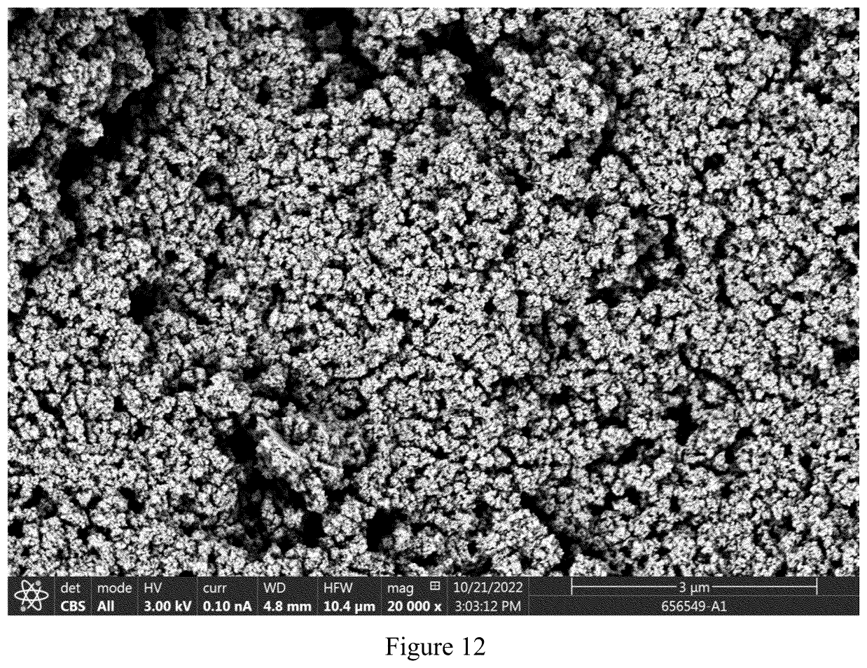

XRD analysis of the as-synthesized product, illustrated in FIG. 11, showed the crystalline material to be of *BEA framework type. FIG. 12 shows a SEM image of the as-synthesized crystalline material of Example 6. Inductively coupled plasma (ICP) analysis indicated the product had a Si/Al₂ molar ratio of 18.76.

The total surface area (TSA) of the calcined version of the crystalline material of Example 6 was 718.15 m²/g, its external surface area (ESA) was 300.6 m²/g, its micropore surface area (MSA) was 417.55 m²/g, and the ratio TSA/ESA was 0.42.

### Example 7: Synthesis of *BEA Zeolite from Silicic Acid and Aluminum Nitrate in the Absence of Sodium, Si/Al₂=50

0.5264 g aluminum nitrate nonahydrate, 12.6755 g of a 1,1-(pentane-1,5-diyl)bis(1-propylpyrrolidinium) hydroxide solution (22.41 w %) and 2.4518 g silicic acid (JT Baker®0324-05 Silicic Acid, n-Hydrate, Powder) were added to a Teflon liner. The mixture was stirred for 5 min after each addition and for 15 min after the last addition. Then 5.5476 g of water was allowed to evaporate under nitrogen flow to produce a synthesis mixture having the following composition in terms of molar ratios:

1SiO₂:0.02Al₂O₃:0.225QOH:7.75H₂O

The synthesis mixture was treated under the following hydrothermal conditions without stirring: heat-up rate as fast as possible, synthesis temperature of 150° C., soak time of 120 hours. The solid material was recovered afterwards by centrifugation, washed several times with water and dried at 120° C.

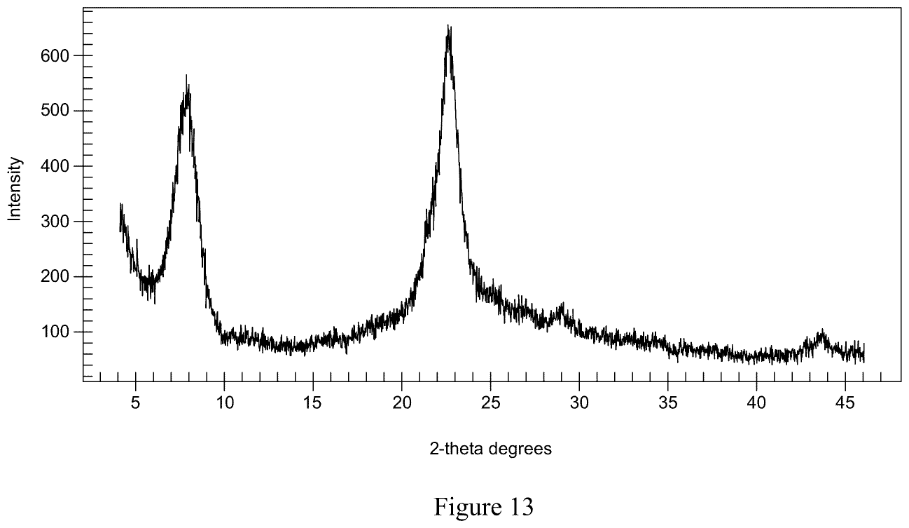

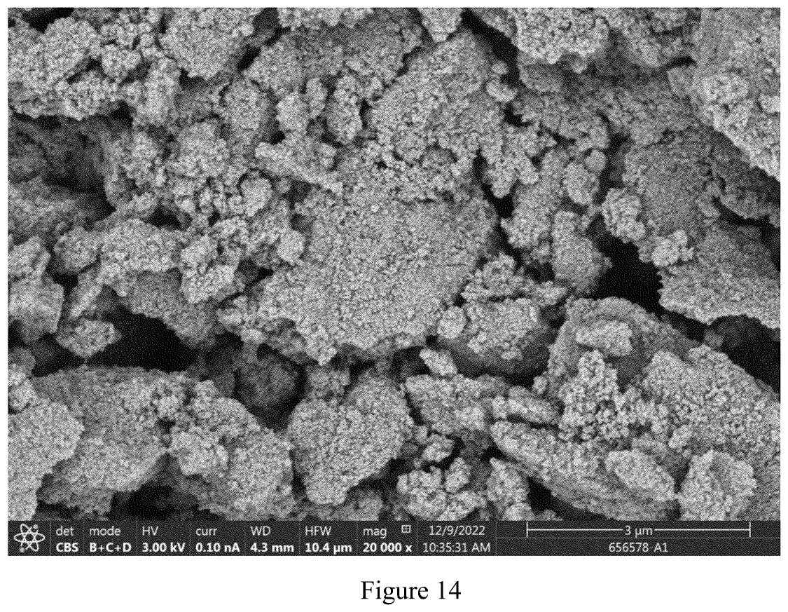

XRD analysis of the as-synthesized product, illustrated in FIG. 13, showed the crystalline material to be of *BEA framework type. FIG. 14 shows a SEM image of the as-synthesized crystalline material of Example 7. Inductively coupled plasma (ICP) analysis indicated the product had a Si/Al₂ molar ratio of 50.85.

The total surface area (TSA) of the calcined version of the crystalline material of Example 7 was 717.5 m²/g, its external surface area (ESA) was 442.8 m²/g, its micropore surface area (MSA) was 274.3 m²/g, and the ratio TSA/ESA was 0.62.

### Examples 8-9 (Comparative): Synthesis of EMM-23

Examples 1 and 2 were reproduced except for a lower amount of NaOH, resulting in synthesis mixtures having the following compositions in terms of molar ratios:

1SiO₂:0.0067Al₂O₃:0.25QOH:0.1NaOH:20H₂O

XRD analysis of the as-synthesized products showed the crystalline materials to be EMM-23.

### Example 10 (Comparative): Synthesis of EMM-23

Example 7 was reproduced with a Si/Al₂ molar ratio of 100, the synthesis mixture having the following composition in terms of molar ratios:

1SiO₂:0.01Al₂O₃:0.225QOH:7.75H₂O

XRD analysis of the as-synthesized product showed the crystalline material to be EMM-23.

While the present invention has been described and illustrated with reference to particular embodiments, it will be appreciated by those of ordinary skill in the art that the invention lends itself to many different alterations, modifications, and variations not specifically illustrated herein. It will also be apparent to those skilled in the art that when numerical lower limits and numerical upper limits are listed herein, ranges from any lower limit to any upper limit are contemplated. Also, all numerical values within the detailed description herein are modified by “about” the indicated value, and take into account experimental error and variations that would be expected by a person having ordinary skill in the art.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

Additionally or alternately, the invention relates to:

Embodiment 1: A method of making a crystalline material of *BEA framework type, comprising (a) preparing a synthesis mixture comprising water, a source of an oxide of tetravalent element (Y), a source of an oxide of trivalent element (X), a structure directing agent (Q) comprising a 1,1-(pentane-1,5-diyl)bis(1-propylpyrrolidinium) dication, a source of hydroxide ions (OH), and optionally a source of alkali and/or alkaline earth metal element (M), said synthesis mixture having the following composition in terms of molar ratios:

| | |
|---|---|
| Y/X₂ | 10 to 200 |
| Q/Y | 0.01 to 1.0 |
| OH/Y | 0.05 to 1.5 |
| M/Y | 0 to 1.5 |
| H₂O/Y | 1 to 80 |

with the proviso that, when M/Y is 0.01 or less, Y/X₂ is less than 100; (b) heating said synthesis mixture under crystallization conditions including a temperature of from 100 to 200° C. for a time sufficient to form crystals of said material; and (c) recovering at least a portion of the crystalline material from step (b).

Embodiment 2: The method of embodiment 1, wherein the structure directing agent (Q) is in the form of a halide, hydroxide or nitrate, preferably wherein the structure directing agent (Q) is in its hydroxide form.

Embodiment 3: The method of embodiment 1 or 2, wherein the tetravalent element (Y) is selected from the group consisting of silicon, germanium, tin, titanium, zirconium, and mixtures thereof, preferably wherein the tetravalent element (Y) comprises silicon, more preferably wherein the tetravalent element (Y) is silicon.

Embodiment 4: The method of any one of embodiments 1 to 3, wherein the trivalent element (X) is selected from the group consisting of aluminum, boron, iron, gallium, and mixtures thereof, preferably wherein the trivalent element (X) comprises aluminum, more preferably wherein the trivalent element (X) is aluminum.

Embodiment 5: The method of any one of embodiments 1 to 4, wherein the synthesis mixture has the following composition in terms of molar ratios:

| Molar | Typical | Preferred | More preferred |
|---|---|---|---|
| ratios | range | range | range |
| Y/X₂ | 20-150 | 30-100 | 30-less than 100 |
| Q/Y | 0.05-1.0 | 0.1-0.8 | 0.1-0.5 |
| OH/Y | 0.1-1.5 | 0.1-1.0 | 0.2-1.0 |
| M/Y (if M present) | 0.05-1.0 | 0.1-0.8 | 0.1-0.5 |
| H₂O/Y | 3-50 | 4-40 | 5-30 |

Embodiment 6: The method of any one of embodiments 1 to 5, wherein the synthesis mixture has a OH/H₂O molar ratio of less than 0.1, preferably from 0.01 to less than 0.1, more preferably from 0.015 to 0.08.

Embodiment 7: The method of any one of embodiments 1 to 6, further comprising treating the molecular sieve recovered in step (c) to remove at least part of the structure directing agent (Q).

Embodiment 8: A crystalline material of *BEA framework type having 1,1-(pentane-1,5-diyl)bis(1-propylpyrrolidinium) dication within its pore structure.

Embodiment 9: The crystalline material of embodiment 8, obtainable by the method of any one of embodiments 1 to 7.

Embodiment 10: The crystalline material of embodiment 8 or 9, that is an aluminosilicate zeolite having a Si/Al₂ molar ratio of from 10 to 50, preferably from 10 to 30, more preferably from 10 to less than 25, as determined by ICP.

Embodiment 11: A crystalline material of *BEA framework type obtainable by the method of any one of embodiments 1 to 7.

Embodiment 12: The crystalline material of embodiment 11, that is an aluminosilicate zeolite having a Si/Al₂ molar ratio of from 10 to 50, preferably from 10 to 30, more preferably from 10 to less than 25, as determined by ICP.

Embodiment 13: The crystalline material of embodiment 11 or 12 having, in its calcined form, a total surface area (TSA) of 600 to 800 m²/g; an external surface area (ESA) of 200 to 500 m²/g, and a ratio of external surface area to total surface area (ESA/TSA) of from 0.2 to 0.8, preferably from 0.3 to less than 0.6.

Embodiment 14: A process of converting an organic compound to a conversion product comprises contacting the organic compound with the molecular sieve of embodiment 13.

1. A method of making a crystalline material of *BEA framework type, comprising:
(a) preparing a synthesis mixture comprising water, a source of an oxide of tetravalent element (Y), a source of an oxide of trivalent element (X), a structure directing agent (Q) comprising a 1,1-(pentane-1,5-diyl)bis(1-propylpyrrolidinium) dication, a source of hydroxide ions (OH), and optionally a source of alkali and/or alkaline earth metal element (M), said synthesis mixture having the following composition in terms of molar ratios:

| | |
|---|---|
| Y/X₂ | 10 to 200 |
| Q/Y | 0.01 to 1.0 |
| OH/Y | 0.05 to 1.5 |
| M/Y | 0 to 1.5 |
| H₂O/Y | 1 to 80 |

with the proviso that, when M/Y is 0.01 or less, Y/X₂ is less than 100,
(b) heating said synthesis mixture under crystallization conditions including a temperature of from 100 to 200° C. for a time sufficient to form crystals of said material; and
(c) recovering at least a portion of the crystalline material from step (b).

2. The method of claim 1, wherein the structure directing agent (Q) is in the form of a halide, hydroxide or nitrate.

3. The method of claim 2, wherein the structure directing agent (Q) is in its hydroxide form.

4. The method of claim 1, wherein the tetravalent element (Y) is selected from the group consisting of silicon, germanium, tin, titanium, zirconium, and mixtures thereof.

5. The method of claim 1, wherein the trivalent element (X) is selected from the group consisting of aluminum, boron, iron, gallium, and mixtures thereof.

6. The crystalline material made according to the method of claim 1, wherein the tetravalent element (Y) comprises silicon, or wherein the trivalent element (X) comprises aluminum, or a combination thereof.

7. The crystalline material made according to the method of claim 1, wherein the tetravalent element (Y) is silicon, or wherein the trivalent element (X) is aluminum, or a combination thereof.

8. The method of claim 1, wherein the synthesis mixture has the following composition in terms of molar ratios:

| Molar ratios | Range |
|---|---|
| Y/X₂ | 20-150 |
| Q/Y | 0.05-1.0 |
| OH/Y | 0.1-1.5 |
| M/Y (if M present) | 0.05-1.0 |
| H₂O/Y | 3-50 |

9. The method of claim 1, wherein the synthesis mixture has the following composition in terms of molar ratios:

| Molar ratios | Range |
|---|---|
| Y/X₂ | 30-100 |
| Q/Y | 0.1-0.8 |
| OH/Y | 0.1-1.0 |
| M/Y (if M present) | 0.1-0.8 |
| H₂O/Y | 4-40 |

10. The method of claim 1, wherein the synthesis mixture has a OH/H₂O molar ratio of less than 0.1.

11. The method of claim 1, wherein the synthesis mixture has a OH/H₂O molar ratio of from 0.015 to 0.08.

12. The method of claim 1, further comprising treating the molecular sieve recovered in step (c) to remove at least part of the structure directing agent (Q).

13. A crystalline material of *BEA framework type having 1,1-(pentane-1,5-diyl)bis(1-propylpyrrolidinium) dication within its pore structure.

14. The crystalline material of claim 13, that is an aluminosilicate zeolite having a Si/Al₂ molar ratio of from 10 to 50, as determined by ICP.

15. The crystalline material of claim 13, that is an aluminosilicate zeolite having a Si/Al₂ molar ratio of from 10 to 30, as determined by ICP.

16. The crystalline material of claim 13, having, in its calcined form, a total surface area (TSA) of 600 to 800 m²/g; an external surface area (ESA) of 200 to 500 m²/g, and a ratio of external surface area to total surface area (ESA/TSA) of from 0.2 to 0.8.

17. The crystalline material of claim 16, wherein the ratio of external surface area to total surface area is from 0.3 to less than 0.6.
